(19) United States
(12) Patent Application Publication
(10) Pub. No.: US 2007/0176900 A1
(43) Pub. Date: Aug. 2, 2007

(54) Controlling cursor speed from a pointing device

(75) Inventor: Sagi Nagar, Modiln (IL)

Correspondence Address: Martin D. Moynihan;PRTSI, Inc., P.O. Box 16446, Arlington, VA, 22215, US

(73) Assignee: Samsung Electronics Co., Ltd., Gyeonggi-do (KR)

(21) Appl. No.: 11/650,971

(22) Filed: Jan. 9, 2007

Related U.S. Application Data
(60) Provisional application No. 60/764,319, filed on Feb. 2, 2006.

(51) Int. Cl. G09G 5/08

(52) U.S. Cl. 345/159

(57) ABSTRACT

A method for controlling cursor speed from a pointing device is performed by first subdividing a displayed image with a user-controllable into a number of areas. The cursor location is defined by cursor location information, for example the X-Y position of the cursor on the display. The displayed image is analyzed to determine a respective window density for each of displayed image areas, where the window density indicates the number of visible elements in the area. When a direction of cursor movement input is received, a cursor speed is selected in accordance with the respective window density of the area in the direction of cursor movement.

### RELATED APPLICATION

This application claims the benefit of U.S. Provisional Patent Application No. 60/764,319, filed Feb. 2, 2006, the contents of which are hereby incorporated by reference.

### FIELD AND BACKGROUND OF THE INVENTION

The present invention relates to utilizing a handheld device, such as a mobile telephone, as a computer pointing device, and, more particularly, to a mobile phone pointing device with context-related cursor movement speed.

There are many cases when a user wants to have some control over his or her personal computer (PC) while being a short distance from it. For example, during presentations a user might want to use a remote pointing device to present a slide show, to open an application or to move the cursor to some arbitrary position on screen in order to emphasize something. Proper control of cursor speed is essential to the ease of operation and usefulness of the pointing device.

Many approaches have been proposed for adapting a handheld device, such as a mobile phone or personal digital assistant (PDA), into a remote pointing device. Such devices typically have simple user interfaces, such as a telephone keypad, which constrain the type of information which can be provided by the user.

When using a simple interface, such as a mobile phone keypad, there is a problem defining the velocity at which the user wants the cursor to move. In current devices, it is typically the operating system which defines a maximum cursor speed, and possibly an acceleration parameter. Alternately, the user manually selects the desired cursor speed. When the selected cursor speed is no longer suitable, the user must stop controlling the cursor position in order to select a new cursor speed.

A first proposed approach is to use a hardware add-on to the mobile telephone, instead of the mobile telephone keypad. U.S. Pat. No. 6,717,572 by Chou et al. teaches a modular rolling axis apparatus which consists of a circuit board, two support elements mounting to the circuit board and a rotary rolling axis located between the two support elements. The rolling axis is manipulated by the user in order to switch or scroll viewing pages on the window. The speed of cursor movement is set manually by the user, rather than being established automatically by the operating system, resulting in the inconvenience described above.

A second approach is to redesign the mobile telephone unit to include non-standard user controls, which adapt the mobile device to function like a mouse or trackball. For example, U.S. Pat. Appl. by Engstrom et al. teaches a combined mobile communication plus pointing device. The mobile device includes a movement mechanism to generate movement signals, which are processed into pointing control signals and transmitted to the proximally disposed computing device. Another example of such a mobile phone is presented in U.S. Pat. Appl. No. 2006/0079279 by Lin, which has a control panel which can slide on a base, so that the control panel can function like a mouse. An additional example is presented in U.S. Pat. Appl. No. 2005/0007343 by Butzer which includes cellular phone hardware and mouse hardware embodied in a single unit.

U.S. Pat. Appl. No. 2006/0040712 by Ansari et al. employs a camera assembly for sensing movement of the device with respect to a surface, or movement of a user's finger over the camera assembly, allowing the hand-held communication device to be utilized as a pointing device, such as an optical mouse or a trackball. However, the finger motion on the camera assembly is determined by comparing the current image with a previous image, a task which requires significant processing resources.

Yet another approach to utilizing a mobile phone as a computer device is the Psiloc Mobile Mouse. The Psiloc Mobile Mouse is a software application, which transforms a Windows Mobile Smartphone into Bluetooth computer mouse. The telephone navigation keys control the mouse position, and the telephone soft keys function as left/right mouse button. The mouse speed is selected manually, from a via an options menu which is opened by pressing the “*” key. Manual selection of the cursor speed is a cumbersome process, which may need to be repeated frequently according to the changing content of the displayed image.

U.S. Pat. Appl. No. 2004/0189714 by Fox et al. teaches techniques for enabling users to define one or more areas of a graphical user interface (“GUI”) as being “glue-like”. When the user moves a pointing device (e.g., a mouse, joystick, track ball, etc.) and as a result, the graphical pointer moves into a painted area, the speed at which the graphical pointer will then traverse the GUI is programmatically slowed. Upon exiting the painted area, the graphical pointer speed is preferably restored to its prior setting. In this manner, the user achieves user-specific, application-independent control over the speed at which the graphical pointer moves. The relative cursor speed is selected manually by the user.

None of the above-described approaches provide a pointing device with automatic adjustment of cursor speed utilizing a standard mobile telephone.

There is thus a widely recognized need for, and it would be highly advantageous to have, a pointing device devoid of the above limitations.

### SUMMARY OF THE INVENTION

According to a first aspect of the present invention there is provided a method for controlling cursor speed from a pointing device is performed by first subdividing a displayed image with a user-controllable into a number of areas. The cursor location is defined by cursor location information, for example the X-Y position of the cursor on the display. The displayed image is analyzed to determine a respective window density for each of displayed image areas, where the window density indicates the number of visible elements in the area. When a direction of cursor movement input is received, a cursor speed is selected in accordance with the respective window density of the area in the direction of cursor movement.

According to a second aspect of the present invention there is provided a system for the control of cursor movement. The system includes a computer and a pointing device. The computer comprises: a display unit, an image analyzer associated with the display unit, and a communication interface associated with the image analyzer. The display unit displays an image comprising a cursor positioned according to cursor location information. The image analyzer subdivides a displayed image into a plurality of areas, and analyzes the displayed image to generate a density map comprising a respective window density for each of the areas, where the respective window density indicates a number of visible elements in an area. The communication interface inputs cursor location information and outputs the density map. The pointing device comprises: a user interface, a communication interface, and a cursor movement determiner. The user interface inputs a direction of cursor movement from a user. The communication interface inputs the density map and outputs cursor location information. The cursor movement determiner selects a cursor speed in accordance with the respective window density of an area in the direction of cursor movement, and generates the cursor location information in accordance with the selected cursor speed and the direction of cursor movement.

According to a third aspect of the present invention there is provided a system for the control of cursor movement by a pointing device connected to a computer by a communication channel. The system includes an image analyzer, a user interface and a cursor movement determiner. The image analyzer subdivides a displayed image into a plurality of areas, and analyzes the displayed image to generate a density map comprising a respective window density for each of the areas, the respective window density indicating a number of visible elements in an area. The user interface inputs a direction of cursor movement from a user. The cursor movement determiner associated with the user interface and the communication interface, configured for selecting a cursor speed in accordance with the respective window density of an area in the direction of cursor movement.

According to a fourth aspect of the present invention there is provided a cursor movement controller, which includes a communication interface, an image analyzer, and a cursor movement determiner. The communication interface inputs a direction of cursor movement from a pointing device. The image analyzer subdivides a displayed image into a plurality of areas, and analyzes the displayed image to determine a respective window density for each of the areas, the respective window density indicating a number of visible elements in an area. The cursor movement determiner selects a cursor speed in accordance with the respective window density of an area in the direction of cursor movement.

According to a fifth aspect of the present invention there is provided a pointing device for the control of cursor movement, which includes a user interface, a communication interface, and an image analyzer. The user interface inputs a direction of cursor movement from a user. The communication interface inputs image data and outputs cursor location information. The image analyzer reconstructs the image data into a displayed image, subdivides the displayed image into a plurality of areas, and analyzes each of the areas to determine a respective window density for each of the areas, the respective window density indicating a number of visible elements in an area. The cursor movement determiner selects a cursor speed in accordance with the respective window density of an area in the direction of cursor movement.

The present invention successfully addresses the shortcomings of the presently known configurations by providing a pointing device with automatic cursor speed control, thereby enabling convenient cursor control from a simple interface, such as a keyboard.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified flowchart of a method for controlling cursor movement from a pointing device, according to a preferred embodiment of the present invention;

FIG. 2a shows a displayed image containing a number of top level windows;

FIG. 2b shows the image of FIG. 2a with highlighted window elements;

FIG. 2c shows the image of FIG. 2b subdivided into nine rectangular areas;

FIG. 3 illustrates an example of a keypad with direction keys for controlling the cursor location;

FIG. 4 is a simplified block diagram of a system for the control of cursor movement, according to a preferred embodiment of the present invention;

FIGS. 5a-5c illustrates a pointing device and PC connected by an IR, Bluetooth, and wire interface respectively;

FIG. 6a is a simplified block diagram of a cursor movement controller, according to a preferred embodiment of the present invention;

FIG. 6b is a simplified block diagram of a pointing device for the control of cursor movement, according to a preferred embodiment of the present invention;

FIG. 7 is a flowchart of a method of opening a connection between the pointing device and the PC, according to a preferred embodiment of the present invention;

FIG. 8a is a flowchart of an iterative method of updating of the density map by the mobile telephone end in response to information received from the computer through the communication interface, according to a preferred embodiment of the present invention;

FIG. 8b is a flowchart of a method for mobile telephone handling of incoming messages, according to a preferred embodiment of the present invention;

FIG. 9 is a flowchart of an iterative method for mobile telephone response to keyboard events, according to a preferred embodiment of the present invention;

FIG. 10 is a flowchart of a method for mobile telephone response to a direction keypad press, according to a preferred embodiment of the present invention;

FIG. 11 is a flowchart of a method for mobile telephone response to keyboard events, according to a preferred embodiment of the present invention;

FIG. 12 is a flowchart of a method for preparing the density map and transmitting density map to an attached client, according to a preferred embodiment of the present invention;

FIG. 13 is a flowchart of a method for the preparation of the density map process for a single area, according to a preferred embodiment of the present invention;

FIG. 14 is a detailed flowchart of a method for computer handling of incoming communications, according to a preferred embodiment of the present invention.

### DESCRIPTION OF THE PREFERRED EMBODIMENTS

The present embodiments are of a pointing device which has automatic cursor speed control which is based on an analysis of the displayed image. Specifically, the present embodiments can be used to utilize a mobile phone as a remote pointing device, with convenient and intuitive control of the cursor speed and location.

In the present embodiments, the displayed image (also referred to herein as the desktop) is analyzed by dividing the desktop into areas, where typically each area is a rectangular portion of the desktop. It is to be understood that the term “displayed image” is not intended to be understood as a single, static image, but rather the continuously updated image displayed on a computer monitor or other display device. Each area is itself analyzed to determine the number of visible elements in the given area, where preferably a visible element is every graphic element that the user can interact with (not just in the main frame window). The number of visible elements in a given area is denoted the area's window density. Information regarding the window density for all of the desktop areas is compiled into a “density map” of the displayed image. Cursor speed is automatically selected according to the density of windows in the direction of cursor movement. As described below, the automatic control of cursor speed may be implemented in several different configurations, depending on the division of tasks between the pointing device and the computer or other display device.

The principles and operation of a pointing device according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In the following, parts that are the same as those in previous figures are given the same reference numerals and are not described again except as necessary for an understanding of the present embodiment.

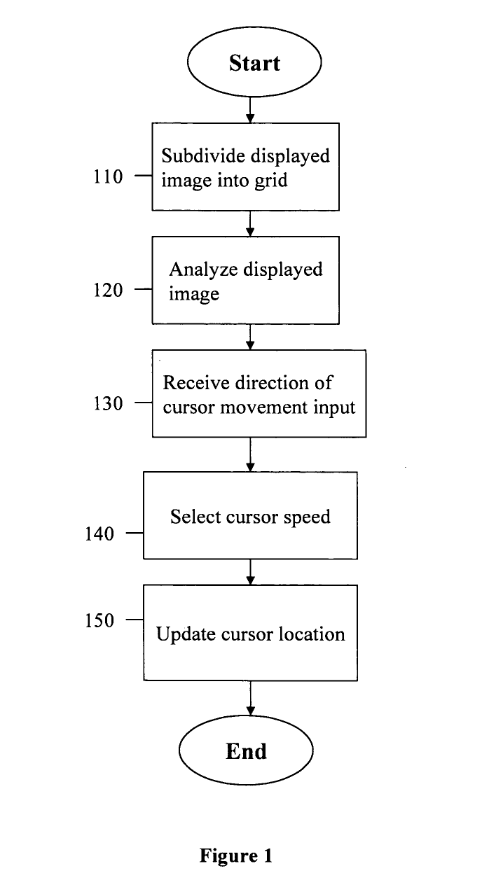

Reference is now made to FIG. 1, which is a simplified flowchart of a method for controlling cursor movement from a pointing device, according to a preferred embodiment of the present invention. The flowchart illustrates the steps performed for cursor speed and location control.

In step 110 a displayed image (also denoted the image) is subdivided into areas. The image includes a cursor at a location selected by a user using a pointing device. In the following the position (also denoted herein the cursor location) of the cursor is considered to be controlled by “cursor location information”. It is to be understood that the location information is not necessarily the absolute cursor location, but may be specified by in other ways, for example by instructing the cursor to move in steps from its current location in a specified direction (e.g. up, down, or sideways).

In step 120 each area of the displayed image is analyzed to determine the respective number of visible elements in the given area (denoted herein the window density). A density map is created indicating the window density for each area of the grid. Note that the window density is preferably determined for top level windows, having visible or partly visible window elements. Hidden window elements are not taken into account for the purposes of calculating the window density for a given area.

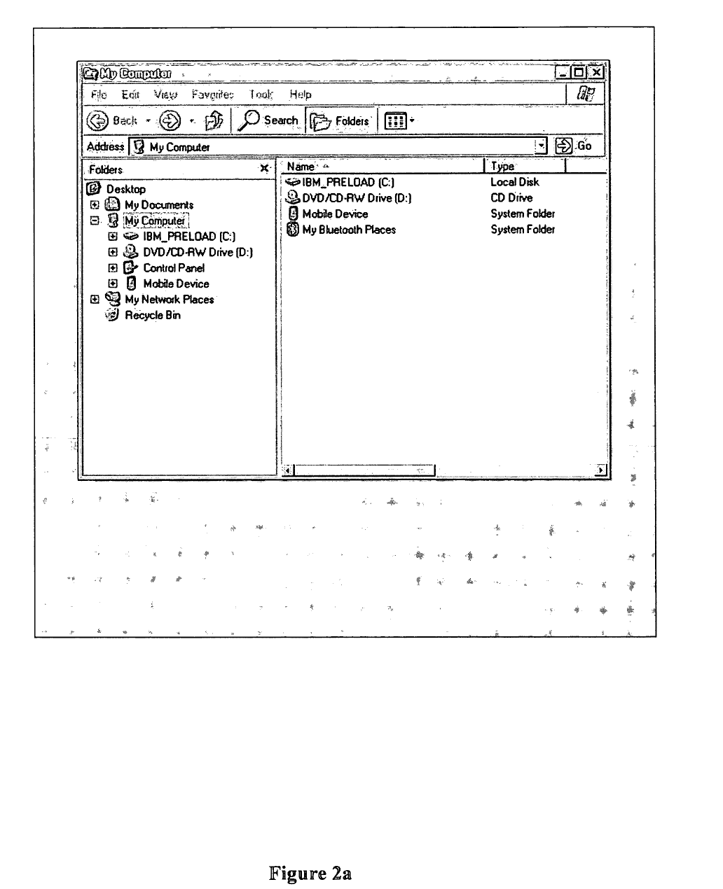

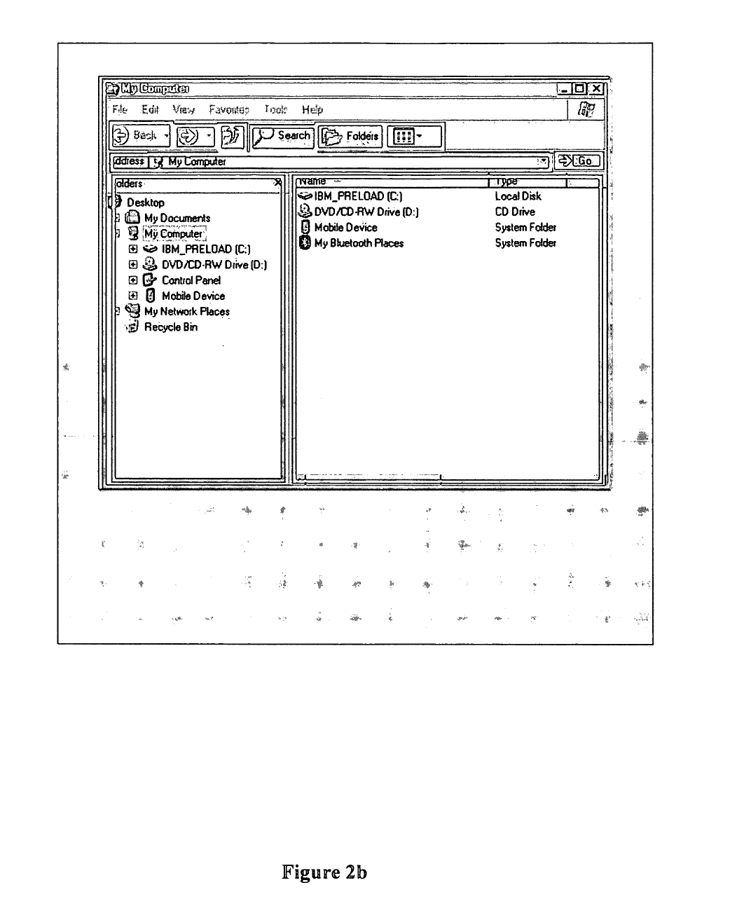

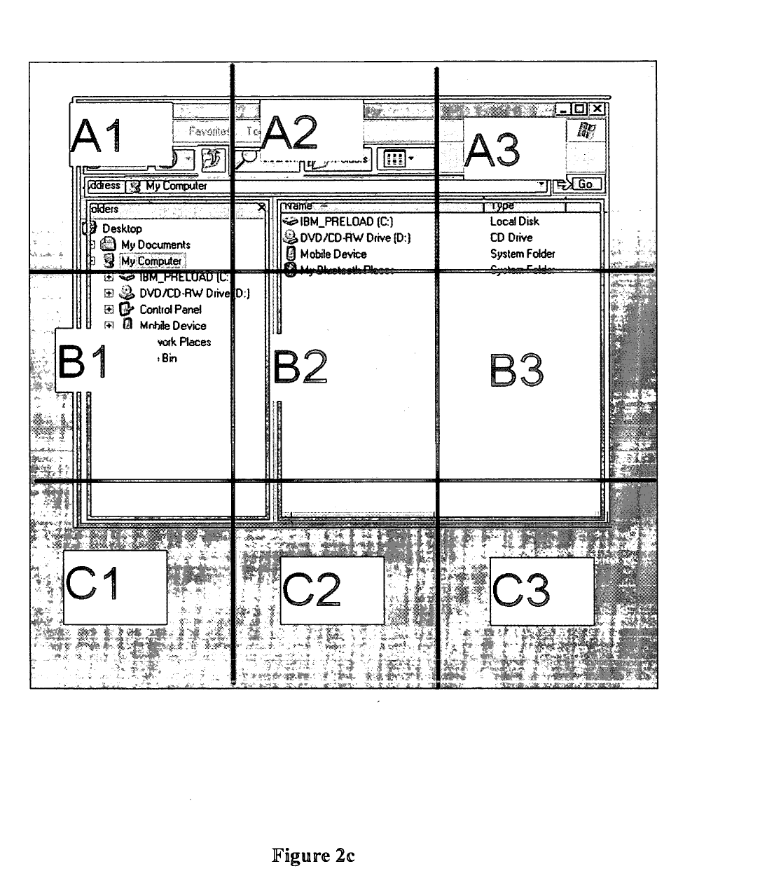

FIGS. 2a-2c illustrates a non-limiting example of how the density map is created. In the present example, a visible object is defined as a top level window. Other embodiments may utilize a different definition of a visible object to include elements such as menu buttons.

FIG. 2a shows a displayed image containing a number of top level windows. For clarity FIG. 2b shows the same image with all the window elements highlighted. FIG. 2c shows the image subdivided into nine rectangular areas (labeled A1-C3). It is expected that in practice the size of the areas into which the image is divided will be smaller, to enable more accurate control of the cursor position.

Table 1 shows the density map, which indicates the number of windows in each area of FIG. 2c.

TABLE 1

| | Number of |
|---|---|
| Area name | windows |
| A1 | 6 |
| A2 | 7 |
| A3 | 4 |
| B1 | 2 |
| B2 | 3 |
| B3 | 2 |
| C1 | 2 |
| C2 | 3 |
| C3 | 2 |

### The density map is updated continuously, to reflect the changes in the displayed image.

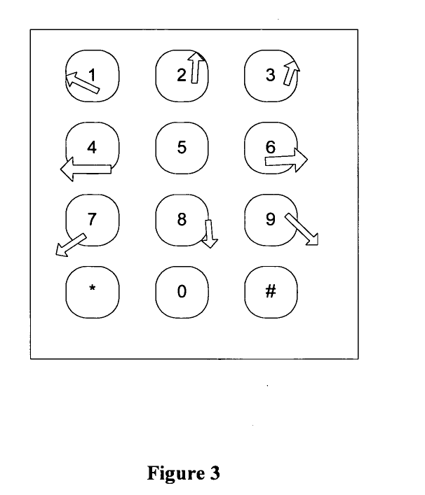

Referring again to FIG. 1, in step 130 a user input is received indicating the direction the cursor should be moved. In the preferred embodiment, the pointing device has a simple keypad, for example a mobile telephone keypad. FIG. 3 illustrates an example of such a keypad, showing the direction indicated by various keys. The bottom buttons (*, 0, #) may be used for mouse clicks.

In step 140, the cursor speed is selected. The cursor speed is selected in accordance with the window density of the area towards which the cursor is moving, as determined from the current cursor location and the user input direction. Preferably, the cursor speed is selected (i.e. updated) upon every user input, in accordance with a continuously updated density map. When the cursor movement is specified in stepwise motions, the cursor speed may be specified as a rate for moving the cursor in steps.

In the preferred embodiment, a high cursor speed is selected if the window density of the indicated area of the grid in the direction of cursor movement is relatively small and a low cursor speed if the window density of the area of the grid in the direction of cursor movement is relatively large. In this way the cursor moves rapidly over “empty” areas of the grid, and slowly over areas which require more sensitive control for user interaction. This motion mimics the way users typically use a mouse to skip quickly over areas of the screen of low interest and move slowly over areas of high interest. The translation of window density to cursor speed may, for example, be performed using a lookup table. An example of how cursor speed in the vertical and horizontal directions may be calculated is given in Eqns. 1a and 1b below.

In a further preferred embodiment, the cursor acceleration is adjusted in addition to the cursor speed. The cursor acceleration may be adjusted to a high value for areas having a small window density and to a low value for areas having a large window density, similarly to the cursor speed.

In the preferred embodiment, the method further includes step 150, of updating the cursor location information in accordance with the direction of movement input and the selected cursor speed. The updated cursor location information may also depend on a time parameter, such as the calculation cycle time, length of keypad press, and/or time period between user inputs.

In the preferred embodiment, the method includes the further step of positioning the cursor on the displayed image in accordance with the updated cursor location information.

In the preferred embodiment, the method includes the further step of changing the pointing device mode of operation. The user may be able to switch between operating modes, in order to obtain a wider range of functions and cursor control options. For example, a second operating mode may use a constant cursor speed for applications in which the automatic adjustment of cursor speed obtained by the above-described embodiment is inappropriate (such as editing bitmap figures). A further mode of operation may be the activation of shortcut keys for operating other functions. Yet another mode of operation may consist of telephone operation in cases where the pointing device is a mobile telephone.

In a further preferred embodiment, after a direction of movement input is received, the window density map is analyzed to predict a window or control the user desires to interact with. The cursor is then moved directly to the vicinity of the predicted window. The cursor motion may then be set to a low speed.

The above-described method may be implemented in various manners, depending upon the division of the tasks between the pointing device and the display device. Several preferred configurations are now presented.

The following embodiments are directed to a pointing device consisting of a mobile telephone which controls cursor movement on images displayed by a computer. However it is to be understood that the present embodiments are not limited to such a configuration. The pointing device may be any device enabling user cursor direction information, such as PDA or a dedicated pointing device. Furthermore, the image may be displayed on any display unit or device capable of the analysis described below, including computer terminals of a central server.

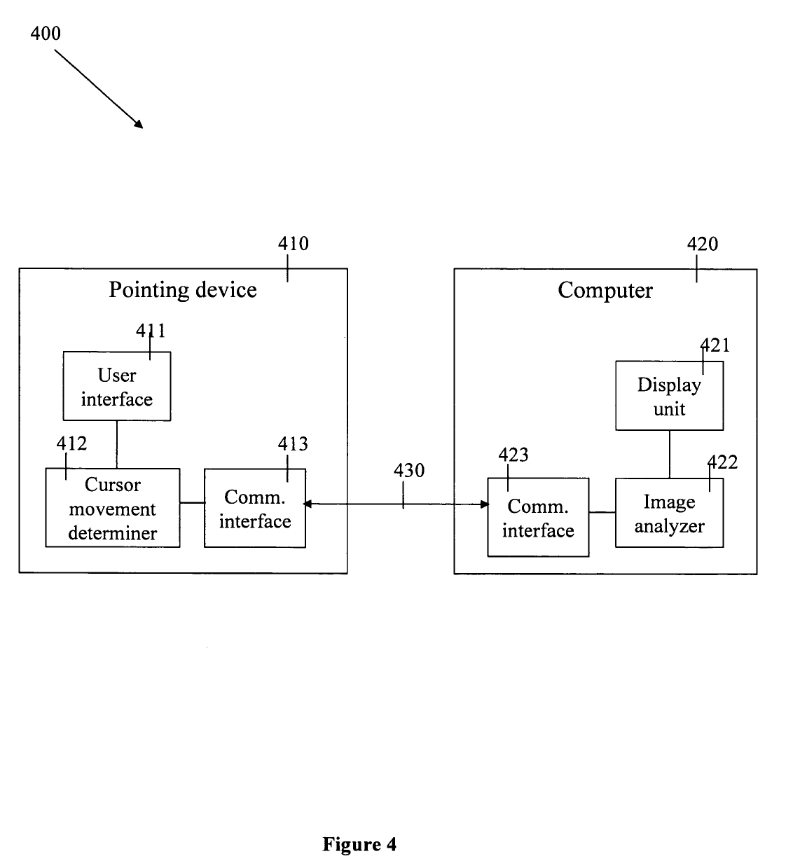

Reference is now made to FIG. 4, which is a simplified block diagram of a system for the control of cursor movement, according to a preferred embodiment of the present invention. System 400 includes a pointing device 410 and computer 420, connected by a communication interface 430 used to exchange information regarding user inputs, cursor direction, density maps and so forth, as required by the system configuration.

The system of FIG. 4 embodies a specific allocation of tasks between the pointing device and a computer. In the present embodiment, computer 420 repeatedly generates a density map for the current displayed image and sends the density map to pointing device 410, which is preferably a mobile telephone. Pointing device 410 receives an updated density map and the current cursor position from computer 420, and, based on the phone keyboard event inputs from a user, calculates a new cursor position, and sends the new position to computer 420. The density map may be temporarily stored in the mobile telephone memory. The pointing device preferably also has functionality to translate designated keyboard information into functions that should be performed by the computer, such as mouse clicks.

Computer 420 includes display unit 421, image analyzer 422, and communication interface 423. Display unit 421 displays images which include a cursor positioned according to cursor location information, which is received from pointing device 410 via communication interface 423. Image analyzer 422 subdivides the current displayed image into areas, and analyzes the displayed image to generate the density map. The density map is sent via communication interface 423 to pointing device 410.

Pointing device 410 includes user interface 411, cursor movement determiner 412, and communication interface 413. User interface 411 receives user inputs, such as keypad presses, indicating the desired direction of cursor movement. Communication interface 413 receives the density map from computer 420 and outputs cursor location information to computer 420. Cursor movement determiner 412 selects the cursor speed in accordance with the window density of an area of the displayed image which is in the direction of cursor movement, and generates the cursor location information in accordance with the selected cursor speed and the direction of cursor movement. In a further preferred embodiment, cursor movement determiner 412 also selects the cursor acceleration.

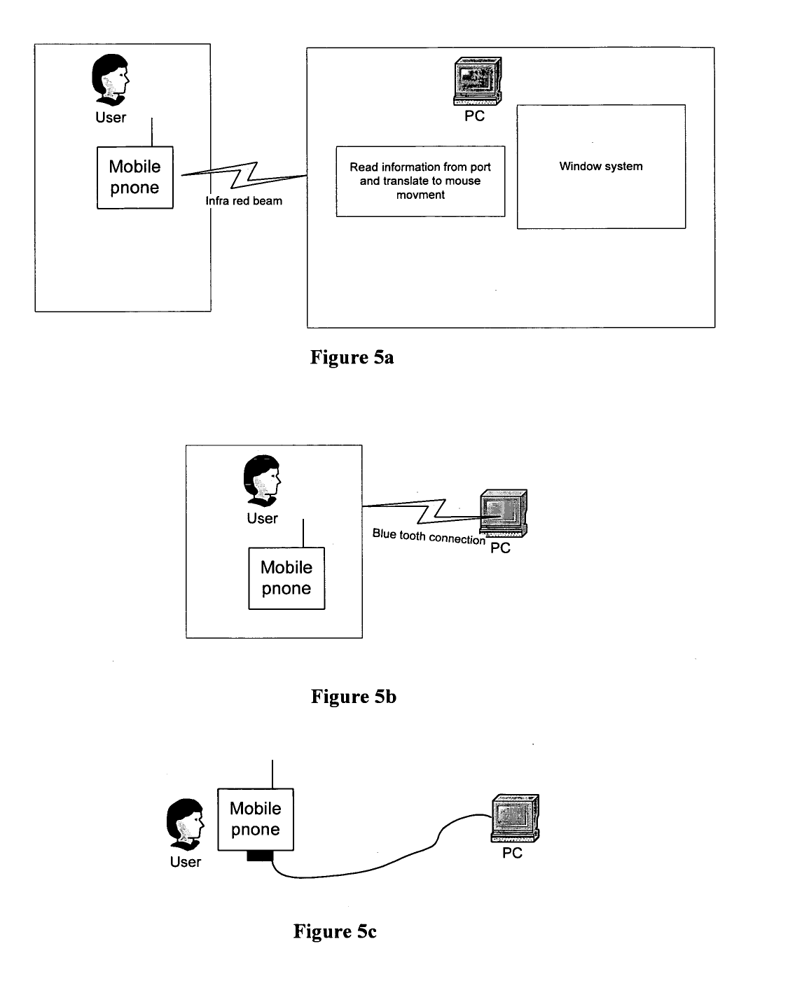

The pointing device and PC are preferably connected by a wireless interface, as shown in FIGS. 5a-5b for infra-red (IR) and Bluetooth communication respectively. Alternately, the pointing device and PC are connected by a wire interface, such as a USB channel, as shown in FIG. 5c. The pointing device preferably registers itself on the PC, if allowed by the type of communication channel (for example Bluetooth or USB), and operates vs. the computer as a standard pointing device, such as a mouse. If unable to register (for example via an IR channel), the computer may have a receiving element or driver that receives the cursor location information and updates the cursor position accordingly.

In the preferred embodiment the pointing device is a mobile telephone. Additionally or alternately the pointing device may be a personal digital assistant (PDA), a dedicated pointing device with keypad, an automotive remote control, or a standard pointing device such as a mouse or joystick.

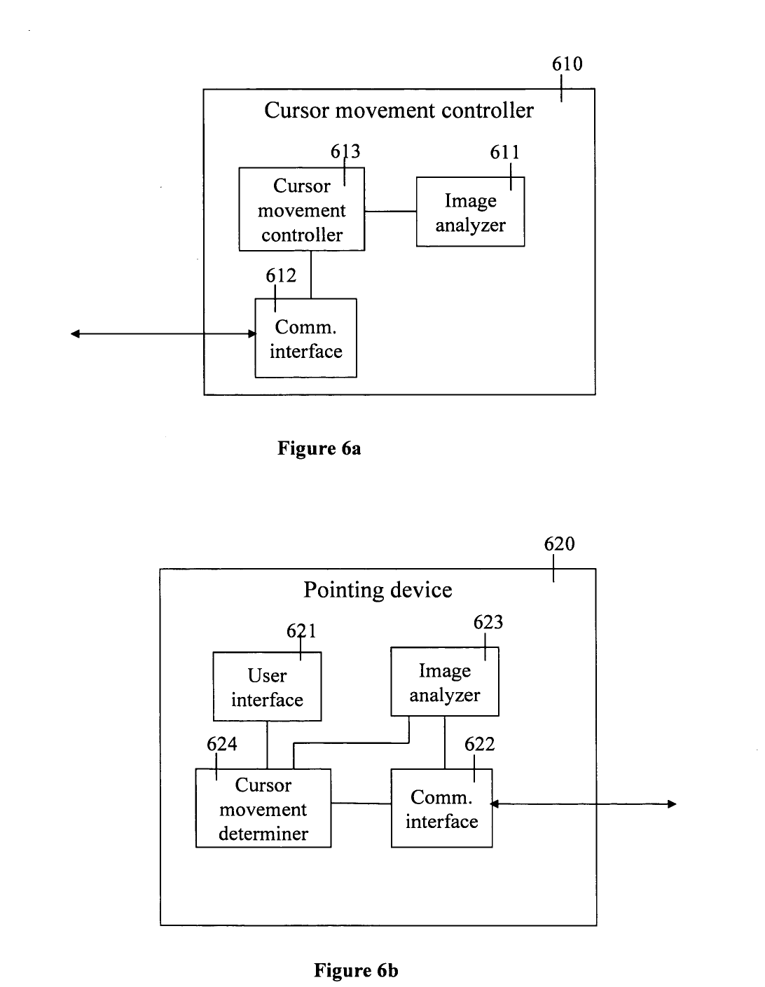

Reference is now made to FIG. 6a, which is a simplified block diagram of a cursor movement controller, according to a preferred embodiment of the present invention. In the present embodiment, the creation of the density map, the selection of cursor speed, and the updating of cursor location are all performed by the computer, based on information received from a pointing device. This information may consist solely of the direction of cursor movement selected by the user. For example, consider a case where the user interface on the pointing device consists of the keypad shown in FIG. 3. The pointing device may simply output a sequence of numbers to the computer, for example 236 to indicate that the user wishes the cursor to move up, diagonally to the right and then up.

Cursor movement controller 610 includes image analyzer 611, communication interface 612, and cursor movement determiner 613. Image analyzer 611 operates essentially as described above, by repeatedly generating a density map for the displayed image. Communication interface 612 receives the direction of cursor movement information (as selected by the user) from a pointing device. The cursor speed is then selected at the computer end by cursor movement determiner 613. Preferably, cursor movement determiner 613 additionally generates the cursor location information for positioning the cursor.

Reference is now made to FIG. 6b, which is a simplified block diagram of a pointing device for the control of cursor movement, according to a preferred embodiment of the present invention. In the embodiment of FIG. 6b, the creation of the density map, the selection of cursor speed, and the updating of cursor location are all performed by the pointing device, based on information received from a computer. This information may consist solely of image data, enabling an analysis of the displayed image in order to generate the density map.

Pointing device 620 includes user interface 621, communication interface 622, image analyzer 623, and cursor movement determiner 624. User interface 621, which preferably includes a keypad, receives direction of cursor movement inputs (e.g. keypad presses) from a user. Communication interface 622 inputs image data provided by the computer, and outputs cursor location information. In the preferred embodiment, the communication channel to the computer is a wireless channel, so that pointing device 620 functions as a remote pointing device. Image analyzer 623 reconstructs the image data into a displayed image, where the term “reconstruct” indicates that the image data is organized in a manner enabling the generation of a density map for the image. Image analyzer 623 then generates a density map from the reconstructed image. Cursor movement determiner 624 selects the cursor speed in accordance with the density map, and preferably also generates the cursor location information from the selected cursor speed and the direction of cursor movement input(s). The cursor location information is then output to the computer over communication interface 622.

In an additional preferred embodiment, a system for the control of cursor movement by a pointing device connected to a computer by a communication channel includes an image analyzer, user interface, and cursor movement determiner, each of which functions essentially as described. The system elements may be included in the pointing device or computer, in accordance with a specific system configuration.

In a further exemplary embodiment, functions implemented at the mobile telephone (or other pointing device) are performed by the processing unit of the mobile telephone, as instructed by a client program installed on the mobile telephone. Likewise, in another exemplary embodiment, the pointing device is configured for communicating with the computer via a standard driver (e.g. a driver for a conventional mouse or joystick).

Additional objects, advantages, and novel features of the present invention will become apparent to one ordinarily skilled in the art upon examination of the following examples, which are not intended to be limiting.

### EXAMPLES

Reference is now made to the following examples, which, together with the above descriptions, illustrate the invention in a non-limiting fashion.

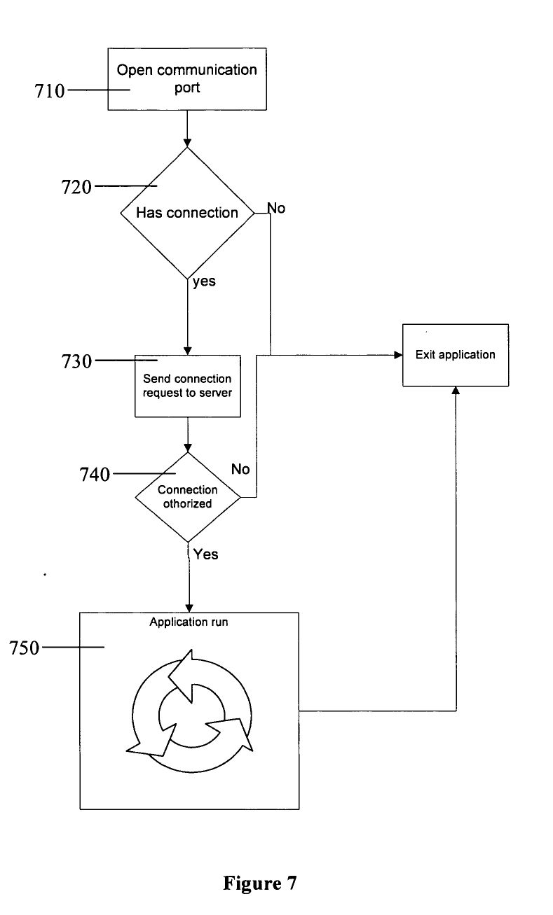

Reference is now made to FIGS. 7-14, which are simplified flowcharts of tasks performed by a system for the control of cursor movement, according to an exemplary embodiment of the present invention. FIGS. 7-14 are directed to a system configuration as described for FIG. 4 above, with a pointing device consisting of a mobile telephone.

The present system includes two main components, the mobile telephone pointing device and a personal computer. The mobile telephone has a resident client which performs the following main activities:

1) Establishes a connection with the computer, in order to receive the density map from the computer and to provide the computer with updated cursor locations.

2) Handles cursor control inputs from the user. Handling user inputs involves listening to keyboard events, translating keypad presses into new cursor position using the density map, and sending the new cursor position back to the computer (e.g. PC).

The main activities of the computer include:

1) Establishes a connection with the mobile telephone, in order to provide the density map to the mobile telephone and to receive the updated cursor locations.

2) Prepares the density map.

3) Displays the image on the desktop, with the cursor positioned as determined by the mobile telephone client.

FIG. 7 is a flowchart of opening a connection between the pointing device and the PC. The mobile telephone begins by attempting to open a communication port with the PC (step 710). If a communication port is found (step 720), the mobile telephone sends a connection request with the mobile telephone's ID (step 730). The PC receives the request and decides whether to allow the communication with the mobile telephone or not (step 740). If the computer authorizes the connection, the computer sends its own ID to the mobile telephone, and the mobile telephone begins the application activity (step 750).

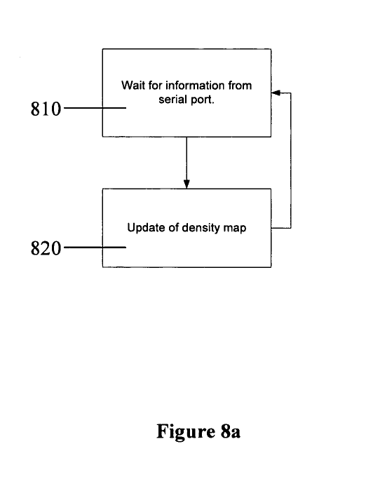

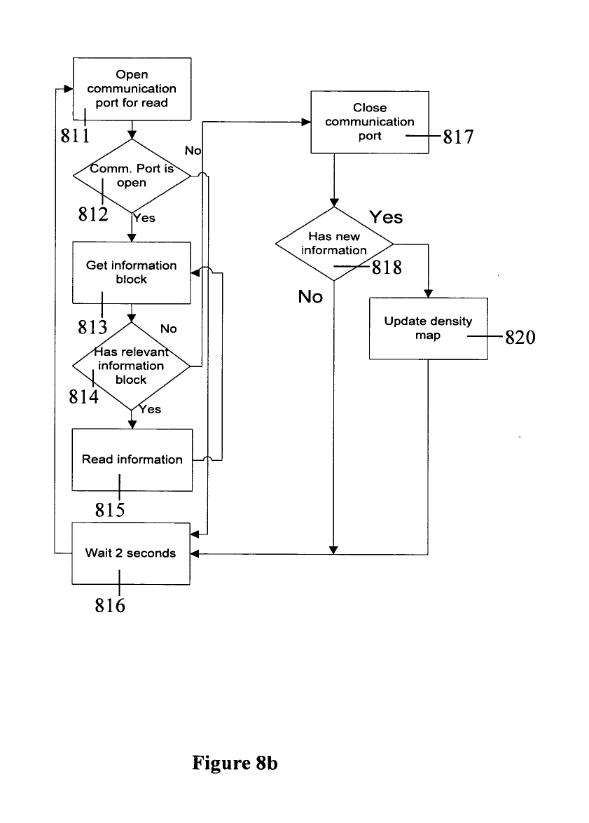

FIG. 8a is a flowchart of an iterative method for updating of the density map by the mobile telephone end in response to information received from the computer through the communication interface. In the present exemplary embodiment the communication interface is a serial port. The mobile telephone monitors the serial port, which is in communication with the PC. If any message (such as a density map update) arrives (step 810), the mobile telephone takes the necessary action. In the case where the message is a density map update, the action taken by the mobile telephone is to update the stored density map (step 820). Another possible message is updated cursor position information from the PC. Once again the mobile phone waits for a message on the event to arrive (step 810), and when the message arrives the mobile telephone updates the stored cursor location (step 820). The mobile phone may use this information in order to calculate a new cursor speed that will affect the cursor's new position.

FIG. 8b is a more detailed flowchart of step 810 of FIG. 8a. The communication port is opened for a read operation (step 811). It is then determined if the communication is open (step 812). If the communication port is not open a wait period occurs (step 816), at the end of which another attempt is made to open the communication port (step 811). If it is determined that the communication port is open, an information block is read (step 813). The information block is checked to determine if the information it contains relates to the window density map (step 814). If the information block is relevant, the information block is read (step 815). The read process proceeds in a loop (steps 813-815) until all relevant information blocks have been read. Once the read process is completed, the communication port is closed (step 817). The obtained information is checked in step 818 to determine whether it contains new information. If so, the density map is updated in step 820. In the present embodiment the wait period is given as 2 seconds, however a different wait period may be selected in accordance with system requirements.

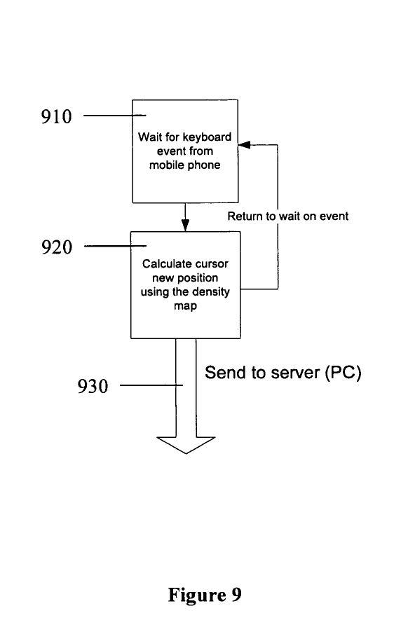

FIG. 9 is a flowchart of an iterative method for the mobile telephone response to user keyboard inputs (denoted herein a keypad press or a keyboard event). The mobile telephone waits for the user to press a key on the mobile phone keyboard (step 910). When a keyboard event arrives, the mobile telephone takes the necessary action. For example, if a mouse movement button is pressed, the mobile telephone calculates the new cursor speed and location (step 920), and sends the updated cursor location to the PC (step 930). Other actions taken by the mobile telephone may emulate mouse button clicks as well as other activities (such as scrolling).

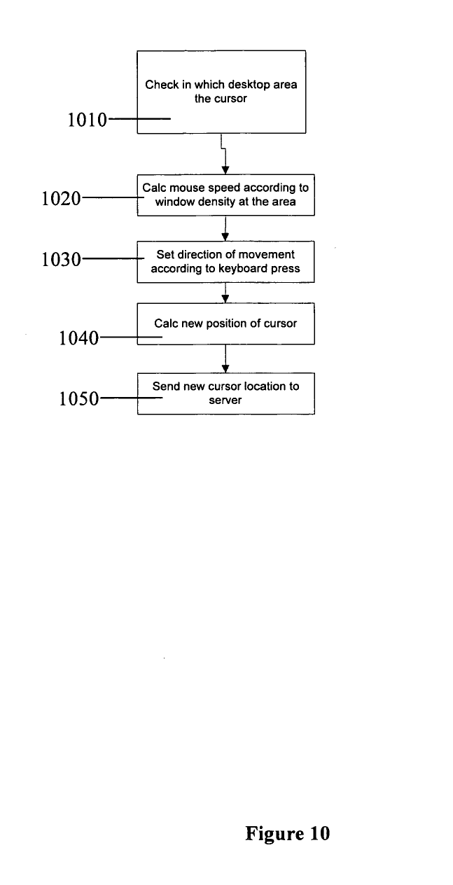

FIG. 10 is a flowchart a method for the mobile telephone response to a direction keypad press (steps 920-930 of FIG. 9), where a direction keypad press indicates a direction of cursor movement (and does not include other user inputs such as mouse clicks). When the user presses a direction key, the mobile telephone checks which area the cursor is currently located in (step 1010). The mobile telephone performs a look up operation to the density map to determine how many windows (i.e. visible elements) are in that area. The cursor speed is set according to the window density given by the density map (step 1020). The new cursor direction of movement is determined by the keyboard press (step 1030), and the new cursor location is calculated in accordance with the magnitude of the cursor speed multiplied by a time parameter such as the cursor position calculation cycle time (step 1040). The new cursor location is then sent to PC (step 1050).

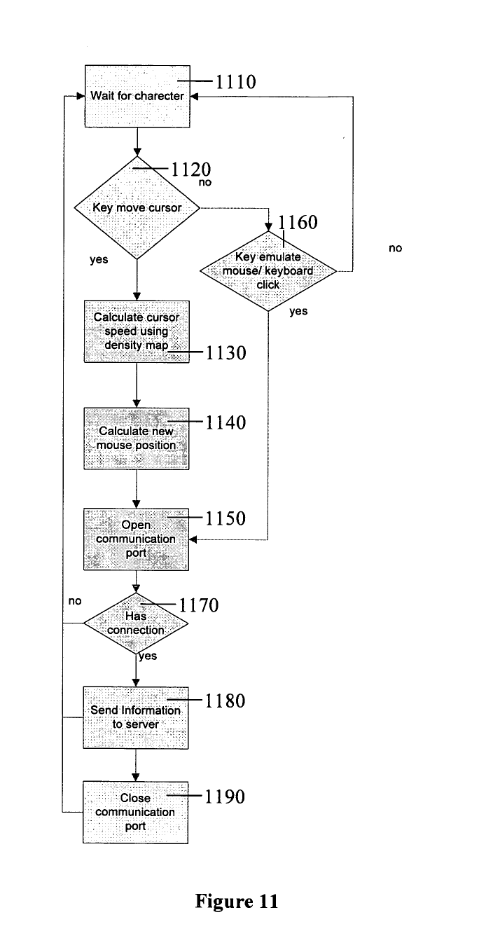

FIG. 11 is a more detailed flowchart of the mobile telephone response to keyboard events, including events which emulate mouse button clicks (rather than direction keypad presses). In step 1110 the mobile telephone waits for a keyboard event. In step 1120 it is determined whether the keyboard event is a direction keypad press or a non-direction keypad press possibly (emulating a mouse button click).

If a direction key has been pressed, the new cursor speed is calculated using the density map in step 1130. An exemplary embodiment for calculating the cursor speed is now described.

Calculating the cursor new position is a two step process. The first step sets the speed of the cursor (the length of the movement vector), and the second determines the direction of the movement vector according to the keypad press. First, the maximum window density in an area of the screen is selected. For example, if the maximum density is set to five and the actual density of a given area is greater than five, the respective value of the density map will nonetheless be set to five.

The cursor speed is determined separately for the X axis and the Y axis, for example as given by Eqns. 1a and 1b respectively.

$$\begin{matrix}SpeedX = ( MaxDensity - CurDensity ) * ( \frac{DesktopWidth}{MaxDensity * 2} ) + 16 & ( 1 a ) \\ SpeedY = ( MaxDensity - CurDensity ) * ( \frac{DesktopHeight}{MaxDensity * 2} ) + 16 & ( 1 b )\end{matrix}$$

SpeedX is the speed on the X axis, SpeedY is the speed on Y axis, MaxDensity is the selected maximum density of a window area, CurDensity is the window density at the area of the displayed image where the cursor is positioned, DesktopWidth is the computer's desktop width in pixels, and DesktopHeight is the computer's desktop height in pixels.

Once the speed of the cursor is determined, the next step is to select multiplication factors that determine the direction of movement. The multiplication factors may be performed by table lookup. For example, Table 2 shows factors for each axis using the keypad assignments of FIG. 3.

TABLE 1

| Keypad | XFactor | YFactor |
|---|---|---|
| 1 | −1 | −1 |
| 2 | 0 | −1 |
| 3 | −1 | 1 |
| 4 | −1 | 0 |
| 6 | 1 | 0 |
| 7 | −1 | 1 |
| 8 | 0 | 1 |
| 9 | 1 | 1 |

In step 1140 the new cursor location is calculated, for example according to Eqns. 2a and 2b below:

NewXPos=OldXPos+XFactor*SpeedX*TimeElapse (2a)

NewYPos=OldYPos+YFactor*SpeedY*TimeElapse (2b)

where NewXPos is the new X position to send to the computer, NewYPos is the new Y position to send to computer, OldXPos is the current X position of the cursor on the PC's display, OldYPos is the current Y position of cursor on the PC's screen, XFactor is the movement factor on X axis taken from Table 1, YFactor is the movement factor on Y axis taken from Table 1, SpeedX is the speed on X axis as calculated by Eqn. 1a, SpeedY is the speed on Y axis as calculated by Eqn. 1b, and TimeElapse is the cycle time for cursor movement calculation.

If a non-direction key has been pressed, it is determined in step 1160 whether the keypad press emulates a mouse or keyboard control (for example a mouse button click or turning a scroll wheel). If so, the keypad press is sent to the computer over the communication port is opened in step 1150. Otherwise, the process resumes at step 1110.

In step 1150 the communication port is opened, in order to send cursor location information or keypad press information to the computer. In step 1170 it is determined whether a connection is established with the computer. If so, the information is sent to the computer in step 1180, and the communication port is closed in step 1190. The process then resumes at step 1110.

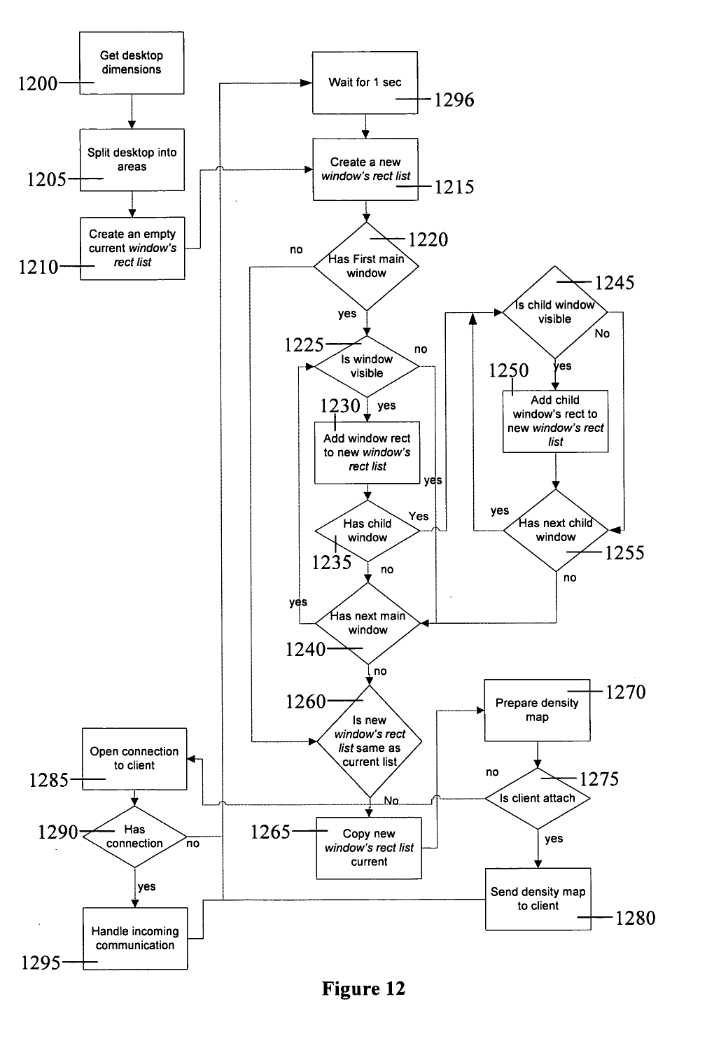

FIGS. 12-14 are simplified flowcharts of tasks performed by a computer communicating with a mobile telephone pointing device.

FIG. 12 is a flowchart of an iterative method for computer preparation of the density map and the transmission of the density map to the attached client. Steps 1200 to 1215 describe the process of subdividing the displayed image into areas and preparing an empty linked list of rectangles, the window's rect list. Each node in the list will hold the screen coordinates of a respective window.

Steps 1220 to 1255 describe the recursive process of determining the number of main and child windows in every area of the displayed image. A main window is a window that has no parent, that is its parent is the desktop. A child window is a window that has a valid parent window (not the desktop). The parent window may be a main window or another child window. The search or iteration through the child windows is recursive, where for clarity steps 1245-1255 describe only the first level of child windows.

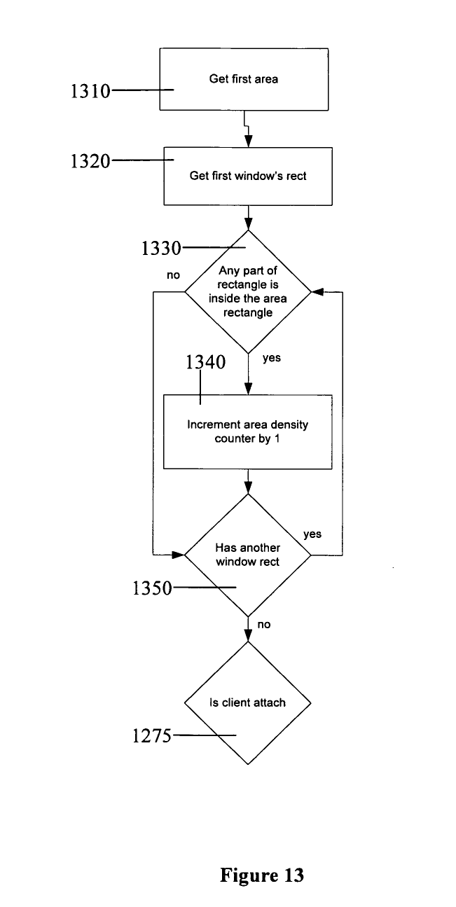

In step 1260 it is determined whether the window's rect list is the same as the previously prepared list. If not, a new density map is prepared in steps 1265-1270 (see also the description of FIG. 13 below).

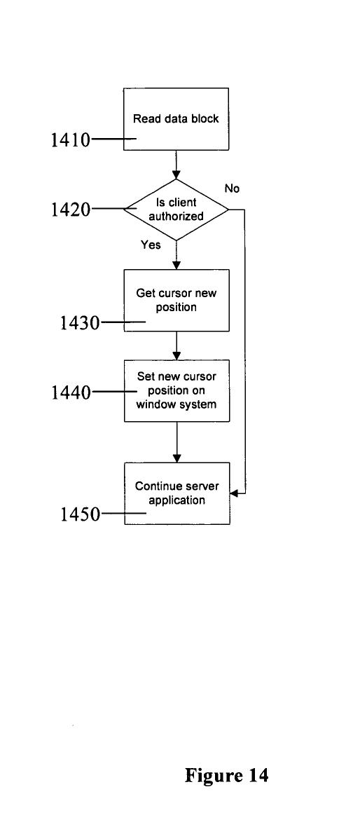

Communications with the client are handled in steps 1275-1295, including sending the density map to the client and receiving incoming communications from the client (see also the description of FIG. 14 below).

The process is performed iteratively, preferably with a wait period between iterations as shown by step 1296.

FIG. 13 is a detailed flowchart of a method for the preparation of the density map process for a single area (e.g. the first area) of the displayed image based on the window's rect list. To find the density of a single area of the desktop (step 1310), the coordinates of each window listed in the window's rect list are examined in turn (steps 1320 and 1350). If any part of a window is inside the current area (step 1330), the density counter is incremented by one (step 1340). The process is repeated for each area of the desktop, thereby providing a complete density map.

FIG. 14 is a flowchart of a method of computer handling of incoming communications. The computer reads in a data block giving cursor location information (step 1410), and determines whether the client is an authorized client (step 1420). If so, the cursor location information is read from the data block (step 1430), the cursor is set to the location given by the received information (step 1440), and the computer application continues (step 1450). If the client is not authorized, the cursor location is left unchanged.

The above-described embodiments provide a user with intuitive and convenient control of a cursor using a pointing device with a keypad user interface. The cursor speed is automatically adapted to the displayed image, in order to move the cursor quickly over areas of low interest while providing accurate control in areas of high interest. A mobile telephone is thus easily adapted to serve as an effective, user-friendly remote pointing device.

It is expected that during the life of this patent many relevant pointing devices, user interfaces for pointing devices, communication channels and interfaces, and display devices will be developed and the scope of the corresponding terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for controlling cursor speed from a pointing device, comprising:
subdividing a displayed image into a plurality of areas, said displayed image comprising a cursor;
analyzing said displayed image to determine a respective window density for each of said areas, said window density indicating a number of visible elements in a respective area;
receiving a direction of cursor movement input; and
selecting a cursor speed in accordance with the respective window density of an area in said direction of cursor movement.

2. A method according to claim 1, wherein said selecting a cursor speed comprises selecting a high cursor speed if said respective window density of said area in said direction of cursor movement is relatively small, and selecting a low cursor speed if said respective window density of said area in said direction of cursor movement is relatively large.

3. A method according to claim 1, wherein said selecting a cursor speed comprises performing a table lookup to determine said cursor speed.

4. A method according to claim 1, wherein said cursor is positioned according to cursor location information and further comprising updating said cursor location information in accordance with said direction of movement input and said selected cursor speed.

5. A method according to claim 4, wherein said updating is further in accordance with a time parameter.

6. A method according to claim 5, wherein said time parameter comprises one of a group comprising: a duration for calculating an updated cursor location, a time period between said direction of cursor movement inputs, and a duration of a direction of cursor movement input.

7. A method according to claim 4, further comprising positioning said cursor in accordance with said updated cursor location information.

8. A method according to claim 1, further comprising transmitting said cursor location over a communication interface.

9. A method according to claim 1, further comprising transmitting a density map comprising said respective window density for each of said areas over a communication interface.

10. A method according to claim 1, further comprising receiving image data and reconstructing said image data so as to determine said respective window densities.

11. A method according to claim 1, further comprising changing a mode of operation of said pointing device.

12. A method according to claim 1, further comprising selecting a cursor acceleration in accordance with the respective window density of said area in said direction of cursor movement.

13. A system for the control of cursor movement, comprising:
a computer comprising:
a display unit configured for displaying an image, said image comprising a cursor positioned according to cursor location information;
an image analyzer associated with said display unit, configured for subdividing a displayed image into a plurality of areas, and for analyzing said displayed image to generate a density map comprising a respective window density for each of said areas, said respective window density indicating a number of visible elements in an area; and
a communication interface associated with said image analyzer, configured for inputting cursor location information and for outputting said density map; and
a pointing device comprising:
a user interface configured for inputting a direction of cursor movement from a user;
a communication interface configured for inputting said density map and for outputting cursor location information; and
a cursor movement determiner associated with said user interface and said communication interface, configured for selecting a cursor speed in accordance with the respective window density of an area in said direction of cursor movement, and for generating said cursor location information in accordance with said selected cursor speed and said direction of cursor movement.

14. A system according to claim 13, said cursor location information comprises said direction of cursor movement and said selected cursor speed.

15. A system according to claim 13, wherein said cursor movement determiner is further operable to calculate an updated cursor position, and to supply said cursor position as said cursor location information.

16. A system according to claim 13, wherein said pointing device comprises a mobile telephone.

17. A system according to claim 13, wherein said pointing device comprises one of a group comprising: a personal digital assistant (PDA), a dedicated pointing device with keypad, a mouse, a joystick, and an automotive remote control.

18. A system according to claim 13, wherein said communication interface comprises a wireless interface.

19. A system according to claim 18, wherein said communication interface comprises one of a group comprising: a Bluetooth interface and an infra-red (IR) interface.

20. A system according to claim 13, wherein said communication interface comprises a wire interface.

21. A system according to claim 13, wherein said pointing device is further configured for operation in a constant speed mode.

22. A system according to claim 13, wherein said pointing device is configured for operation in a shortcut mode.

23. A system for the control of cursor movement by a pointing device connected to a computer by a communication channel, comprising:
an image analyzer configured for subdividing a displayed image into a plurality of areas, and for analyzing said displayed image to generate a density map comprising a respective window density for each of said areas, said respective window density indicating a number of visible elements in an area;
a user interface configured for inputting a direction of cursor movement from a user; and
a cursor movement determiner associated with said user interface and said communication interface, configured for selecting a cursor speed in accordance with the respective window density of an area in said direction of cursor movement.

24. A system according to claim 23, wherein said cursor movement determiner is further configured for generating cursor location information for positioning said cursor, in accordance with said selected cursor speed and said direction of cursor movement.

25. A system according to claim 23, wherein said cursor movement determiner is further configured for selecting a cursor acceleration in accordance with the respective window density of said area in said direction of cursor movement.

26. A cursor movement controller, comprising:
a communication interface, configured for inputting a direction of cursor movement from a pointing device;
an image analyzer, configured for subdividing a displayed image into a plurality of areas, and for analyzing said displayed image to determine a respective window density for each of said areas, said respective window density indicating a number of visible elements in an area; and
a cursor movement determiner associated with said communication interface and said image analyzer, configured for selecting a cursor speed in accordance with the respective window density of an area in said direction of cursor movement.

27. A cursor movement controller according to claim 26, wherein said cursor movement determiner is further configured for generating cursor location information for positioning said cursor, in accordance with said selected cursor speed and said direction of cursor movement.

28. A pointing device for the control of cursor movement, comprising:
a user interface configured for inputting a direction of cursor movement from a user;
a communication interface configured for inputting image data and for outputting cursor location information;
an image analyzer associated with said communication interface, configured for reconstructing said image data into a displayed image, subdividing said displayed image into a plurality of areas, and for analyzing each of said areas to determine a respective window density for each of said areas, said respective window density indicating a number of visible elements in an area; and
a cursor movement determiner associated with said user interface, said communication interface and said image analyzer, configured for selecting a cursor speed in accordance with the respective window density of an area in said direction of cursor movement.

29. A pointing device according to claim 28, wherein said cursor movement determiner is further configured for generating said cursor location information in accordance with said selected cursor speed and said direction of cursor movement.

30. A pointing device according to claim 28, wherein said user interface comprises a keypad.

31. A pointing device according to claim 28, wherein said communication interface comprises a wireless interface.
